(19) United States
(12) Patent Application Publication
(10) Pub. No.: US 2022/0327382 A1
(43) Pub. Date: Oct. 13, 2022

(54) SYSTEMS AND METHODS FOR MACHINE LEARNING OPTIMIZATION

(71) Applicant: MASTERCARD INTERNATIONAL INCORPORATED, Purchase, NY (US)

(72) Inventors: Conor SEXTON, Dublin (IE); Ahmed MENSHAWY, Dublin (IE)

(21) Appl. No.: 17/710,863

(22) Filed: Mar. 31, 2022

(30) Foreign Application Priority Data
Apr. 9, 2021 (GB) 2105115.6

(51) Int. Cl. G06N 3/08; G06N 3/04; G06K 9/62

(52) U.S. Cl. CPC G06N 3/08; G06N 3/0454; G06K 9/6257

(57) ABSTRACT

A computing system optimises a machine learning process. At the application level, the computing system comprises: a processing master pod maintaining a shared work queue comprising machine learning model training operations, each model training operation comprising an associated set of hyperparameter configurations to be evaluated during the course of the training operation, wherein each training operation is executed for a pre-defined number of iterations; a shared repository storing records, each record corresponding to one of the model training operations in the shared work queue; and processing worker pods, and: accessing a model training operation; retrieving the corresponding record for the accessed model training operation; executing the pre-defined number of iterations for each of the obtained one or more model training operations; and for each executed iteration, outputting evaluation result data associated with the corresponding iteration to the shared repository for storage in the corresponding record.

### CROSS-REFERENCE TO RELATED APPLICATION

This application claims the benefit of GB Patent Application No. 2105115.6, which was filed on Apr. 9, 2021, the entire contents of which are hereby incorporated by reference for all purposes.

### TECHNICAL FIELD

The present disclosure relates to a system and method for computing optimization, particularly in relation to machine learning, and more specifically in relation to optimizing machine learning model performance.

### BACKGROUND

Machine learning capabilities have a wide range of applications and provide improvements in relation to solving computational and data-intensive problems across a variety of technical fields.

It is known for complex machine learning model training and utilisation to involve a parallel computing implementation, whereby each training run or job is placed in a queue of such jobs that are to be carried out by or allocated to free computing resources as they become available.

Performance of any given machine learning model is governed to a large extent by the initial training of that model. In particular, adjusting the values of the model hyperparameters typically results in a significant impact on the performance of the associated model, and correspondingly on the performance of the computing system implementing that model. As is well known in the technical field of machine learning, the term ‘hyperparameter’ is used to refer to those model parameters that contribute to controlling the training process and which are hence defined prior to the training process being carried out; this is in comparison with the other model parameters that are derived during the training process itself. Some examples of model hyperparameters are the number of layers in a neural network; the number of nodes in each layer; or the learning rate.

The optimisation of these hyperparameters, a process also commonly referred to in the technical field as ‘hyperparameter tuning’, is therefore important to maximise the predictive accuracy, and hence the performance, of the associated machine learning model. This hyperparameter tuning process typically involves adjusting the values of a given set of hyperparameters and determining those hyperparameter values (or combinations of values) that yield an optimal model and minimise associated loss. Although this tuning process can be performed manually, automated hyperparameter tuning mechanisms exist which improve the efficiency of the hyperparameter tuning process.

### SUMMARY OF THE DISCLOSURE

According to an aspect of the present disclosure, there is provided a computing system for optimising a machine learning process. The computing system may be implemented using a cluster computing infrastructure comprising a plurality of computing nodes, and may comprise at the application level: a processing master pod, a shared repository and a plurality of processing worker pods. The processing master pod may be arranged to manage the optimisation of the machine learning process, and may be configured to maintain a shared work queue comprising a plurality of machine learning model training operations, each model training operation comprising an associated set of hyperparameter configurations to be evaluated during the course of the training operation, wherein each training operation is configured to be executed for a pre-defined number of iterations. The shared repository may be configured to store a plurality of records, each record corresponding to one of the model training operations in the shared work queue. Each of the plurality of processing worker pods may be in operative communication with the shared work queue and the shared repository, and may be configured to: access, from the shared work queue, a model training operation; retrieve, from the shared repository, the corresponding record for the accessed model training operation; execute the pre-defined number of iterations for each of the obtained one or more model training operations; and for each executed iteration, output evaluation result data associated with the corresponding iteration to the shared repository for storage in the corresponding record.

The above-described application processing architecture (also used subsequently to refer to the computing system architecture at the application level) enables multiple training operations and/or jobs to be executed simultaneously by the plurality of worker pods, with the corresponding advantages in optimising computing resource use that such parallelised processing functionality provides. At the same time though, oversight and management of the entire training process is maintained via use of a master pod and the shared queue. Overall control and allocation of the various training jobs based on the respective computing processing and storage resources available to each of the worker pods, is achieved, thereby optimising computational efficiency of the system as a whole whilst minimising the processing load on any given processing entity. Furthermore, progress of any given training job can be tracked via use of the shared repository to and from which data can be written, edited and read by the plurality of worker pods; and such progress may also be monitored centrally by the master pod.

In some instances, each model training operation has an associated completion time period within which execution of each of the iterations is to be completed. In some examples, upon expiration of the completion time period, if the execution of the corresponding iteration is incomplete, the iteration is deemed to not have been successful; and the model training operation is configured to be returned to the shared work queue for access and execution by a different one of the plurality of processing worker pods. Optionally, each worker pod is configured to, after executing each iteration of the model training operation, reset the completion time period in relation to a subsequent iteration of the model training operation.

The implementation of an associated completion time in association with each training job iteration allows a realistic yet optimised timescale to be set within which any given worker pod should be able to complete a training job iteration using its allocated computing resources. The entire training operation can therefore be completed as efficiently as possible. In addition, as mentioned above, a mechanism is also provided whereby the progress of a training job can be tracked; this ensures that where any given iteration of a training job cannot be completed successfully by a particular worker pod, the training job can be returned to the queue to be picked up by another worker pod within a suitable amount of time. In particular, where the completion time is reset after each operation, a very short period of time can be associated with the completion time; this in turn ensures swift detection that any given worker pod has been unable to complete a particular training iteration (and hence the rest of its allocated training job), for example in the scenario where the worker pod crashes or has a processing failure mid-way through a training job. The short completion time period ensures that the time lag between the worker pod crashing/failing, and the job thereafter being returned to the queue for processing by a different worker pod, is minimised. This therefore also maximises computing efficiency.

In some examples, each worker pod is further configured to, upon retrieving the corresponding record for the model training operation: determine whether the accessed model training operation has previously been executed by a different processing worker pod, and if so, determine the last successful iteration of the model training operation; and implement the executing and outputting steps in respect of each of the remaining iterations that are not deemed successful. Those portions of a training operation/job that were not successfully completed by the original/previous worker pod assigned to that training job can be executed by a new worker pod, whilst minimising the amount of processing power and effort that this new worker pod has to put into executing that job; the new worker pod can simply pick up the processing where the previous worker left off and the transition between the worker pods is relatively seamless and straightforward. The overall computing resource usage for the entire suite of training operations is optimised and processing efficiency is maximised. This functionality is facilitated by the common shared queue and the shared data repository/store that contains a record of all the training jobs and allows job progress and status to be tracked.

Optionally, each worker pod is configured to, upon determining that the accessed model training operation has previously been executed by a different processing worker pod, access the corresponding record in the shared repository and delete any evaluation result data stored in association with the record in respect of all iterations subsequent to the last successful iteration. As the shared repository is accessible to all of the worker pods, the constituent stored records within the repository for each training job can each be read, edited and written to by each of the worker pods when carrying out the respective training job. Such accessibility and editing functionality enables new worker pods carrying out the remaining iterations of a previously semi-completed training job to effectively police the data recorded by the previous worker pods to work on the training job. Any artefacts resulting from failure of a worker pod to complete a given training job (or one of its iterations)—e.g., incomplete records, errors in the data recordal or other artefacts caused by the worker pod crashing—can be removed from the corresponding data record in the shared repository by the next worker pod to pick up that training job. This is useful to ensure that such failure artefacts do not adversely affect the final result that is obtained during analysis at the end of the optimisation process.

In some instances, the set of hyperparameter configurations for each model training operation comprises one or more of the following: (a) a combination of hyperparameter input values; (b) a hyperparameter search space; (c) an objective metric to be achieved as a result of the model training operation; and (d) a search algorithm to be used. Optionally, where the set of hyperparameter configurations comprises a combination of hyperparameter input values, these hyperparameter values may be randomly generated. It will also be appreciated that due to the parallelised functionality provided, the above-described application processing system will particularly lend itself towards implementation where the training jobs can be compartmentalised and executed independently from one another (e.g., stateless search algorithms). For example, where the set of hyperparameter configurations comprises a search algorithm to be used and especially where this search algorithm corresponds to a random search function or a grid search function. Such search algorithms do not require knowledge of previous/prior hyperparameter settings or values to be executed, and hence are especially suitable for parallel processing implementations.

According to another aspect of the present disclosure, there is provided a computer-implemented method for optimising a machine learning process. The method comprises: creating, by a processing master pod, a shared work queue comprising a plurality of machine learning model training operations, each model training operation comprising an associated set of hyperparameter configurations to be evaluated during the course of the training operation, wherein each training operation is configured to be executed for a pre-defined number of iterations. The method may further comprise maintaining, by a shared repository, a plurality of stored records, each record corresponding to one of the model training operations in the shared work queue. The method may further comprise, for each of a plurality of processing worker pods in operative communication with the shared work queue and the shared repository: accessing, from the shared work queue, a model training operation; retrieving, from the shared repository, the corresponding record for the accessed model training operation; executing the pre-defined number of iterations for each of the obtained one or more model training operations; and for each executed iteration, outputting evaluation result data associated with the corresponding iteration to the shared repository for storage in the corresponding record.

The method may further comprise, upon retrieving, by the processing worker pod and from the shared repository, the corresponding record for the model training operation: determining, by the processing worker pod, whether the accessed model training operation has previously been executed by a different processing worker pod, and if so, determine the last successful iteration of the model training operation; and implementing, by the processing worker pod, the executing and outputting steps in respect of each of the remaining iterations that are not deemed successful.

Optionally, upon determining that the accessed model training operation has previously been executed by a different processing worker pod, the method may further comprise: accessing, by the currently implementing worker pod, the corresponding record in the shared repository; and deleting, by the currently implementing worker pod, any evaluation result data stored in association with the record in respect of all iterations subsequent to the last successful iteration.

In some instances, each model training operation has an associated completion time period within which execution of each of the iterations is to be completed. Upon expiration of the completion time period, if the execution of the corresponding iteration is incomplete, the method may further comprise: the iteration is deemed to not have been successful; and the model training operation is configured to be returned to the shared work queue for access and execution by a different one of the plurality of processing worker pods. Optionally, the method may further comprise: resetting, by the worker pod and after executing each iteration of the model training operation, the completion time period in relation to a subsequent iteration of the model training operation.

In some cases, the machine learning model may be a neural network, for example a deep neural network (or DNN), as tuning of the internal structure of neural networks (and particularly optimisation of the hyperparameter settings) can make a significant contribution to the optimisation of the overall predictive power of the neural networks.

It will be appreciated that similar benefits and advantages will be associated with the methods as were described previously in association with the application processing systems and/or the computing infrastructure implementing these methods. In addition, corresponding features as were described above in respect of any of the systems and their component entities implementing these methods will also be applicable to the methods themselves

Within the scope of this application, it is expressly intended that the various aspects, embodiments, examples or alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments or aspects will now be described, by way of example only, with reference to the accompanying drawings, in which:

FIG. 1 is a schematic block diagram of the computing system architecture at the application level arranged to implement a hyperparameter tuning process according to aspects of the present disclosure;

FIG. 2 is a flow diagram illustrated steps involved in the hyperparameter tuning process implemented using the system of FIG. 1;

FIG. 3 is a flow diagram illustrating a method of error-handling implemented as part of the tuning process of FIG. 2 and using the system of FIG. 1.

Where the figures laid out herein illustrate embodiments of the present disclosure, these should not be construed as limiting to the scope of the disclosure. Where appropriate, like reference numerals will be used in different figures to relate to the same structural features of the illustrated embodiments.

### DETAILED DESCRIPTION

A system and method for automated hyperparameter tuning according to the present disclosure will now be described, which is implemented using cluster computing resources. Initially however, in order to provide context and background for implementation of this system and method, a general description of cluster computing architecture and how this architecture may function in relation to machine learning will now be described.

In general, a cluster computing architecture comprises a plurality of processing nodes or computing machines that together make up the cluster. Specifically, each cluster comprises a ‘master’ node, and one or more ‘worker’ or ‘minion’ nodes. The master node corresponds to the main controlling unit of the cluster, and is configured to manage the workload distribution within the cluster as well as communication across the worker nodes in the system. The worker nodes host and provide the computing resources that enable various applications to be run simultaneously (i.e., in parallel) using the cluster.

More specifically, each worker node comprises or corresponds to one or more ‘pods’ that are deployed onto a given computing node entity. Each pod defines or provides a certain disk volume that is exposed to or used by one or more various applications for use in executing their desired functions, operations or computing ‘jobs’. In addition, each pod may also comprise an associated storage volume that can be used to provide a shared disk space for applications executing within that node. In even greater detail, each pod comprises one or more ‘containers’ that are co-located on the same computing entity and which can share the computing resources—disk volume and storage volume—provided by their host pod. Considered another way, a container constitutes the basic unit of the cluster computing system; one or more containers, hosted on a given computing node entity, are used to execute functions of the applications running on the cluster as desired.

The above-described cluster computing architecture is thereby able to partition and manage the resources of a computing cluster so as to maximise the parallelisation of the functions that are desired to be executed by one or more applications, and to maximise the efficiency with which an overall job can be completed by the cluster.

Now that the underlying cluster computing architecture has been described, more detail will now be provided in relation to implementing machine learning workflows using this architecture, and specifically in relation to automated hyperparameter tuning experiments. Before doing so however, it is noted that the applications of these experiments will be particularly beneficial in relation to machine learning workflows which utilise neural networks, and especially those involving deep neural networks (DNNs). Such DNNs comprise one or more ‘hidden’ layers between their input and output layers, and effectively constitute a ‘black box’ with complex internal structure and relationships (which do not necessarily attempt to read onto any real-world features); tuning of this internal structure optimises the predictive power for the outputs of the DNN based on the provided inputs. DNNs are therefore particularly useful for modelling complex non-linear relationships, and hence find implementations across a variety of technical fields, for example image processing and recognition; bioinformatics; drug discovery; financial fraud detection and medical image analysis. However, due to their complex ‘black box’-like internal structures (the added ‘hidden’ layers of abstraction within the network), it will also be appreciated that DNNs can be particularly susceptible to issues associated with overfitting; and can incur significant computational time and resource costs due to the need to optimise multiple different training parameters. The automated tuning experiments implemented using cluster computing architecture that are described herein are therefore particularly advantageous in relation to optimising such hyperparameters for DNNs, as they can provide improvements in relation to tuning those hyperparameters that are utilised to prevent overfitting. However, whilst overfitting is one of the main challenges that is addressed via hyperparameter tuning, tuning of hyperparameters that are not in place specifically to address overfitting will nevertheless contribute towards the overall goal of efficient use of computational resources during such model parameter optimisations, as will be noted subsequently.

Any given hyperparameter tuning experiment comprises multiple model training ‘jobs’, ‘operations’ or ‘trials’ (hereafter simply referred to collectively as jobs), whereby each job is defined with the aim of testing a different set or combination of hyperparameter configurations for a particular machine learning model. In more detail, an experiment begins with the definition of multiple model training jobs which involves the definition of (for each job): various different configuration settings which effectively define the job itself; the objective metric or target which is used to validate the accuracy of the machine learning model in that job; the hyperparameter search space (e.g., including a list of the hyperparameters to be optimised, maximum and minimum values of the hyperparameters and other constraints); and the search algorithm that is to be used (e.g., randomised searches, grid searches, linear regression etc.). The results of each job are output upon completion of that job and once all the jobs are completed, or after a desired pre-defined objective is reached, whichever occurs first, the experiment is complete. The outcomes of the jobs in the completed experiment are then analysed and assessed, and the results—i.e., the optimised values of the hyperparameters—are output to the user of the system.

In relation to the cluster computing architecture described above, a computing application implementing a hyperparameter tuning experiment may comprise analogous application architecture that is run using the associated ‘pods’ and ‘containers’ that are implemented using the cluster computing nodes. For example, the application architecture may comprise a master processing ‘pod’ which oversees the overall application processing and manages resource allocation to one or more worker processing pods. Using this computing application architecture, each job in a given hyperparameter tuning experiment—i.e., each machine learning model (comprising a certain combination of hyperparameter configurations) that is to be trained and tested—may be implemented using one or more of the worker pod(s) and container(s). The overall experiment is ‘overseen’ and managed by the master pod, which maintains a shared work list, schedule or work ‘queue’ (hereafter simply referred to as a queue) of all the machine learning models that are to be tested in the experiment. The individual worker pods access the queue in order to obtain or retrieve one or more jobs for execution using the application(s) running in their container(s). In this way, multiple different training jobs can be run in parallel using the plurality of worker pods in the application architecture, and also making beneficial use of the resources made available in the underlying computing cluster architecture.

An example implementation of a cluster computing architecture is Google's Kubernetes architecture which may be used for a multitude of different purposes (e.g., implementing machine learning workflows).

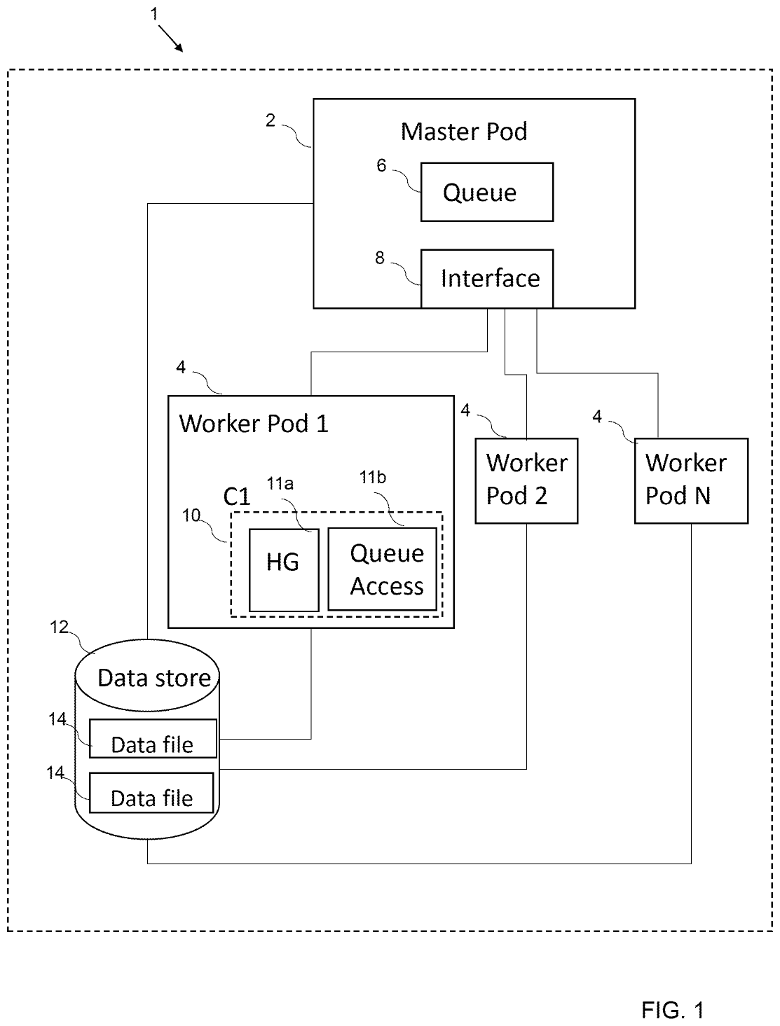

The computing application system of the present disclosure and an overview of how a hyperparameter tuning experiment may be implemented using such an application system will now be described in detail with reference to FIG. 1.

The application system 1 (i.e., the application level of the computing system) comprises a master processing pod 2 (hereafter simply referred to as a ‘master pod’) and a plurality of worker processing pods 4, labelled as Worker Pod 1, Worker Pod 2, and Worker Pod N, indicating that there may be any number N of worker pods, (hereafter simply referred to as ‘worker pods’). The master pod 2 comprises, retains and manages a queue 6 of machine learning model training jobs. As set out above, each job has a particular combination of hyperparameters settings that are to be tested, and together all of the jobs in the queue 6 form a single hyperparameter tuning experiment. The master pod 2 further comprises one or more interface modules or mechanisms 8, for example an API (Application Interface Program), which provides internal and/or external interface functionality for the master pod 2, and (in the case of external interface) thereby for the whole application system 1 as a whole. For example, this interface module 8 may be accessible to the user of the application system 1 to input and configure the details of the experiment (e.g., using command-line programming on a computing device (not shown) of the user). Additionally or alternatively, the interface module 8 may also be used by the individual worker pods 4 to communicate with the master pod 2, and to thereby access the queue 6 containing the jobs that are to be executed by the worker pods 4.

In FIG. 1, each worker pod 4 is shown as a single entity; however, it will be appreciated that as described earlier in relation the underlying cluster computing architecture, each worker pod 4 may in practice be implemented in the form of one or more computing ‘pods’ which are deployed onto a given computing node entity, the operation of which falls within the ‘umbrella’ control functionality of the cluster computing architecture. It will also be appreciated that the master pod 2 may comprise other sub-components that (for simplicity) are not shown in FIG. 1. For example, a scheduler module or sub-component (not shown) may be used to correctly allocate and match the available underlying computing resource supply provided by the computing nodes to the workload demand that is associated with the various pods running on each of the computing nodes. In this manner, the computing resource may be dynamically balanced between various computing nodes by allocating pods to different nodes based on the available resources.

As was also mentioned earlier, each worker pod 4 comprises a plurality of containers 10 within which one or more applications 11 may be executed in order to run the training jobs. Although only a single container “Cl” is shown in association with the worker pod 4 labelled “Worker 1” for simplicity and ease of understanding, it will be understood that the corresponding functionality can also be provided by each of the other N worker pods. Furthermore, it will be appreciated that whilst the components in the system of FIG. 1 are shown schematically as individual blocks of computer processing infrastructure, each of these pods 2, 4 should not be interpreted to strictly correspond on a one-to-one basis to individual (semi-permanent) computing hardware components, but rather to the self-contained software providing the combination of processing functionality that is required, executed using underlying computing infrastructure such as a networked server system. As such, a given worker pod 4 may be created or spawned as necessary onto a particular computing entity to provide the appropriate computing resources for implementation of the training jobs in the experiment. Considered in another way, the application system processing architecture or the architecture at the application level (i.e., the master and worker pods) is abstracted from the underlying cluster computing infrastructure upon which the application(s) is/are implemented. The master pod 2 may potentially be implemented on the ‘master computing node’, and the worker pods 4 may be implemented on one or more of the ‘worker computing nodes’, but this is not necessarily the case (and in any event, the mapping relationship between processing pods and computing nodes will not necessarily be one-to-one).

Specifically, in FIG. 1, the container labelled “Cl” (which may also be referred to as a ‘training container’) is configured to comprise and enable execution of two applications 11a, 11b: a first application 11a labelled “HG” (which in this case stands for ‘Hyperparameter Generator’); and a second application 11b labelled “Queue Access”. As will be appreciated from the names, the first HG application 11a comprises the necessary programming capability and functionality required to generate the various (randomised) hyperparameter settings that are used during the tuning experiment—as mentioned, these settings include the ranges of hyperparameter values within which to limit the training and tuning optimization process; in addition, the HG application is configured with the software code and instructions that are used to execute and run a given training job—namely, to train the model using the given hyperparameter settings. The second Queue Access application 11b is configured to enable the associated worker pod 4 to access (for example via the interface module 8) the queue 6 of hyperparameter tuning jobs that is being maintained by the master pod 2.

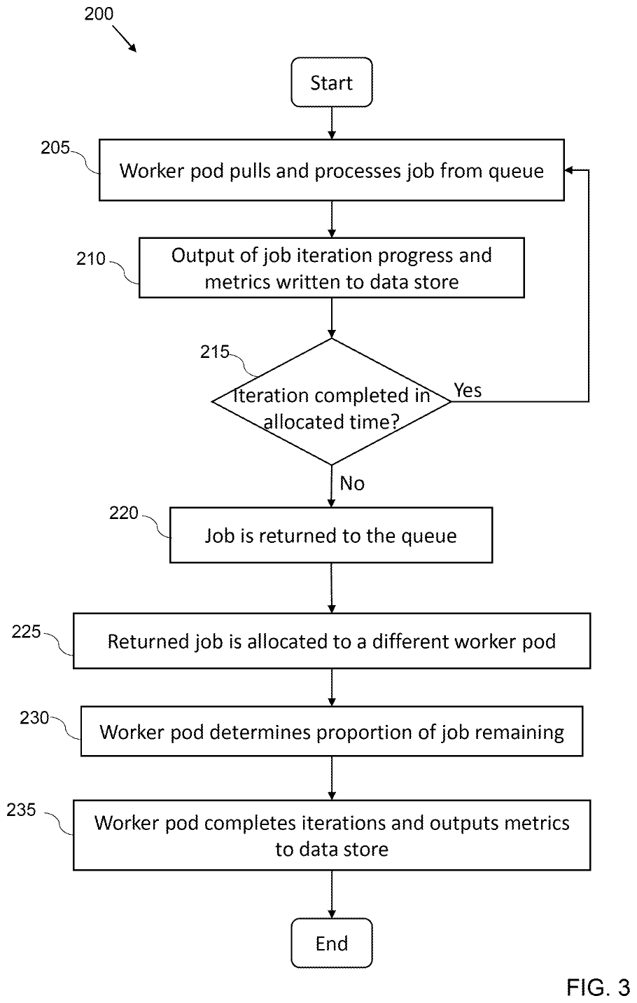

The system further comprises one or more data stores or repositories 12, although for ease of understanding and simplicity only a single data store is shown in FIG. 1. This data store 12 provides storage functionality for the outputs of the training jobs that are run as part of the experiment. As illustrated by the figure, each of the worker pods 4 is able to access the data store 12, and hence the data store 12 may be considered to constitute a shared repository for the plurality of worker pods 4. Furthermore, such access is bi-directional, insofar as the worker nodes 4 are configured to be able to both read input data from and write output data to the data store 12, and more specifically to one of a plurality of data files or records 14 that are stored in the data store 12 and which are each associated with one of the jobs in the queue 6. In greater detail, the worker nodes 4 are able to output evaluation results obtained after completion of each iteration of a training job to the data files 14 in the data store 12, thereby documenting progress of a training job; in addition, the worker pods 4 are also able to read the stored data associated with a particular job (which has been allocated to that node) from the data store 12 when beginning processing of a job. As will be described in greater detail subsequently with reference to FIG. 3, this may include retrieving details of a training job such as the number of iterations that are to be carried out to complete the job.

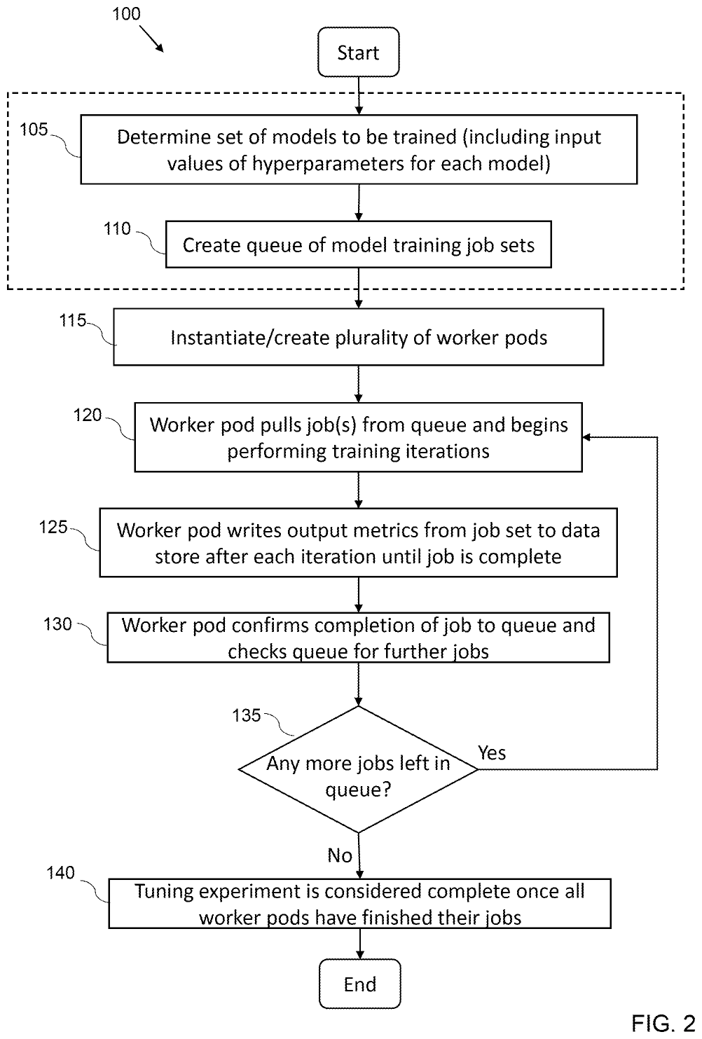

Turning now to FIG. 2, an overall process 100 for using the application processing system of FIG. 1 to implement a hyperparameter tuning experiment will now be described. The process 100 begins with a setup or initialization phase (shown in Steps 105 to 110, and indicated by the box with dashed lines) where the queue of jobs that will constitute the experiment is created. In this phase, the set of machine learning models that are to be trained and tested in the course of a job are defined; each model comprises a particular set of hyperparameter values which are to be evaluated and considered over the course of a specific number of iterations of the corresponding search algorithm. Once the list of model training jobs to be carried out has been defined in Step 105, the queue 6 comprising all of these jobs is created in Step 110, and is thereafter maintained by the master pod 2 using the corresponding queue handling module/functionality described earlier (for ease of reference, the queue itself, the queue handling module and its functionality will all be referred to using the numeral 6). In some examples, this master pod 2 may be controlled by the user running the experiment using the interface module 8 and via command-line input from a computing device of the user.

Subsequently, the next phase of the process involves executing the various training jobs in the queue by the plurality of worker pods 4. This phase begins by instantiating or creating a plurality of worker pods 4 in Step 115. Subsequently, each worker pod 4, having an associated amount of memory and computer processing unit (CPU) resources available to it from the underlying computing infrastructure, accesses or reads from the queue 6 in Step 120 the job(s) that it can process given its capabilities and ‘pulls’ these jobs for execution. The ability for a given worker pod 4 to ascertain its job(s) capacity is enabled by a specification associated with each job, which (among other information) defines the number of iterations that are to be executed in order to complete that job. This job specification may also include a specific completion time period that is associated with a particular iteration of that job; and the job specification information is also comprised in the data files 14 contained in the data store 12.

The worker pods 4 then each begin to run the training jobs that they have pulled from the queue 6, executing the necessary number of iterations for each job. Upon completion of each job iteration, the worker pod 4 outputs in Step 125, to the associated data file 14 in the data store 12, the evaluation results obtained from that iteration of the training job.

Once a worker pod 4 has begun to run iterations of a model training job that it has accessed from the queue, a few different scenarios may play out. In a first ‘complete success’ scenario, the worker pod 4 is able to complete the job(s) accessed from the queue 6 successfully—i.e., all of the required iterations to be executed for that training job are completed within their associated completion time period and the corresponding evaluation results for each iteration (as well as any final output metrics from the job as a whole) are output and written to the corresponding data file 14 contained in the data store 12. In this scenario, the worker pod 4 may also be configured to provide confirmation to the queue 6 (maintained by the master node 2) that the job(s) which have been allocated to that worker pod 4 have been completed. These completed jobs are then marked or otherwise indicated in the queue 6 as having been completed, and that these jobs do not need to be accessed by any other worker pods. This process is carried out in Step 130. Subsequently, the worker pod 4 is now free to once again to access the queue 6 to determine in Step 135 if there are any jobs remaining that have not been allocated to other worker pods 4, and which also match the computing resources of the accessing worker pod 4 in question. If any free (unallocated) jobs remain, the worker pod 4 repeats Steps 120 to 130: pulling the job(s) that can be handled using the memory and computer processing capability available; running iterations of that job; and writing the evaluation results of each iteration to the corresponding data file 14 in the data store 12.

However, if there are no longer any unallocated jobs remaining in the queue, the accessing worker pod 4 in question is considered to have completed its tasks and to be no longer required. After all of the worker pods 4 have completed their jobs, and there remain no outstanding jobs in the queue 6, the experiment as a whole is considered complete. The evaluation results and output metrics that have been written to the individual data files 14 in the data store 12 can then be analysed to ascertain the final outcome of the experiment—in other words, to identify the optimal hyperparameter settings that should be used when applying that machine learning model to test data for different implementation purposes.

The above-described cluster computing infrastructure, the application processing system implemented thereby and its corresponding method of hyperparameter tuning for machine learning models has multiple associated advantages in relation to maximising efficiency of computing resource use whilst minimising processing time and load on any given computing entity. The parallelisation provided by the cluster computing architecture and the application processing system architecture allows multiple different model training jobs to be implemented and executed simultaneously by allocating the amount of work required for these training jobs appropriately based on the processing and storage capacity of each of the worker pods 4. Nevertheless, the queue of jobs that are to be completed and the tuning experiment as whole can still be managed and controlled centrally by the user via the master pod 2. This parallelised computer processing mechanism is particularly suited to and advantageous for the implementation of hyperparameter search algorithms that are stateless—i.e., where the knowledge of results from previous hyperparameter testing is not required to operate—such as random searches and grid searches. Multiple random or grid search settings can be executed independently from one another using the parallelised approach of the application level processing system described herein.

It will however be appreciated that the first ‘complete success’ scenario in which every worker pod 4 completes all its allocated jobs successfully, is effectively an ideal (theoretical) scenario. In practice, there will usually be one or more worker pods 4 that are not able to complete all of their allocated jobs successfully, but will instead ‘crash’ and fail to complete some or all of their allocated job(s). The details of such a scenario, and in particular how crashes/failures/faults of the worker pods are handled by the application processing system of FIG. 1, will now be described with reference to FIG. 3.

As shown in FIG. 3, this process 200 begins at Step 205 which mirrors Step 120 of process 100 that was shown and described in relation to FIG. 2—namely, the worker pod 4 pulls or accesses a job from the queue 6 that matches the computing resources available to that worker pod 4. Subsequently, in line with Step 125 of process 100, the worker pod 4 begins to execute its allocated job in Step 210, by performing the iterations of training in turn and writing the output evaluation results of each iteration to the associated data file 14 in the data store 12.

As mentioned previously, iterations of a training job have an associated completion time period—i.e., a predefined time within which it is anticipated that a given iteration should be completed by a worker node operating under normal conditions—and completion of all of the training job iterations within their associated completion time periods results in successful completion of the overall job itself. However, if it is determined in Step 215 that the worker pod 4 is unable to complete any iteration of its allocated model training job within the corresponding completion time period, the job will be returned to the queue and may then be subsequently re-allocated to another worker pod 4. The completion time period may therefore also be referred to as the ‘leasing period’ since it is the time period which determines whether the job remains leased from the queue 6 by the worker pod 4 executing the job, or returned thereto. This return of the job to the queue may occur if the worker pod 4 crashes, or if the availability of its memory or processing resources is decreased or reduced for any reason to the point where the worker pod 4 is unable to complete the job iteration within the corresponding completion time period. In some cases, the leasing periods may be monitored by the master pod 2 (or a sub-component thereof): where it is determined that the leasing period for a particular job has expired, the master pod 2 may access the queue 6 and alter a status of that job such that it may thereafter be accessed by (and allocated to) a different worker pod 4 for completion.

In this particular illustrated example, the completion time period is associated with a specific iteration of the job—namely, the first iteration that is to be performed in the job—and is arranged to be re-set (by the worker pod 4 itself) upon successful completion of that iteration and to begin ‘running’ again in relation to each subsequent iteration. It will therefore be appreciated that in this case, the completion time period may be defined to correspond to a relatively short period (e.g., Comment for Inventors: Please give some practical examples of such period, or ranges of possible periods). This dynamic update and refresh of the completion time period by the processing worker pod 4 in relation to each subsequent iteration in a particular job is particularly advantageous in relation to fault-handling for the present system. This is because the delay between the point in time where the worker pod 4 crashes (and is unable to continue executing the training job), and the point in time where the job is returned to the queue 6 (and hence can be re-allocated to a new worker pod 4), is minimised. The efficiency with which all the jobs in the experiment can be processed is thereby increased, even when faults or errors develop in one or more of the worker pods in the system.

It will however be appreciated that the fault-handling process may instead be configured to operate in a slightly different manner. For example, additionally or alternatively, a completion time period may be set in association with the training job as a whole, such that if the entire job (i.e., all of the iterations) is not completed by the worker pod 4 within a particular allotted time, this will be considered by the system to constitute a ‘failure’ of the worker pod 4. The job will therefore be returned to the queue 6 as described earlier and may subsequently be re-allocated to a different worker pod.

The above fault-handling process comprises some additional aspects that are particularly evident when a worker pod 4 pulls up a previously failed (semi-complete) job from the queue 6.

As discussed earlier, the worker pod 4 which initially executed some or all of a particular job (hereafter referred to as the ‘original worker node’) would have, as part of its normal job-processing functionality, written the evaluation results obtained for each completed iteration of that training job to the corresponding data file 14 in the data store 12. As a result, this data file 14 contains a record of all of the successfully completed iterations for a given job. After the original worker pod 4 has crashed and the job is returned to the queue 6, the subsequent worker pod 4 to which this job is allocated (hereafter referred to as the ‘new worker node’) will, prior to executing the job, access in Step 230 the corresponding data file 14 for that job from the data store 12. As a result, the new worker pod 4 will be able to identify, prior to executing the job, the last successfully completed iteration for that job; the remaining proportion of the job to be completed is therefore also able to be ascertained in this step. This determination ensures that the new worker pod 4 will then be able to execute only the remaining proportion of the job which the original worker pod 4 was not able to complete. In other words, the new worker node 4 will define, as its job iteration starting point, the iteration number of the last successfully-completed iteration, and then continue to process the job as usual thereafter in the same manner as would have been done in relation to a ‘fresh’ (i.e., not previously allocated or semi-complete) job. This means that the new worker pod 4 will then proceed in Step 235 to complete the remaining iterations of the job, whereby for each successful completed iteration the new worker pod 4 will: output the evaluation results to the corresponding data file 14 in the data store 12; update/re-set the completed time period in relation to the subsequent iteration; repeat these two steps until all iterations are completed; and finally update the queue 6 with a ‘job complete’ status indicator.

Furthermore, as part of the fault-handling process, when reading the job information from the corresponding data file 14 in the data store 12, the new worker pod 4 is also configured to delete any data or data files that were output to the data store 12 by the original worker pod 4 in respect of subsequent (incorrect or incomplete) iterations of the job in question (i.e., after failure or crash of that original worker pod 4) because these data files will not be representative of the results of the job. Alternatively, it may be possible for the new worker pod 4 to simply overwrite the previously-output incorrect data files (associated with the incomplete iterations) with new data from the subsequent iterations that the new worker pod 4 successfully completes.

As will be appreciated, the above-described fault-handling mechanism provides multiple advantages. For example, the new worker pod 4 is able to pick up/take-over the execution of any given training job relatively seamlessly from where the original worker pod 4 ceased its processing; any delays in processing time as a result of such faults are thereby minimised, and any duplicated processing on the part of the new worker pod 4 is thereby avoided. The effect on the processing resources of the overall system, as well as on the processing time required for the entire experiment, is therefore minimised if any worker pod fails or crashes over the course of the experiment. In addition, as the new worker pod 4 which picks up the semi-complete job is configured to delete or overwrite any incorrect data files created by the original worker pod 4 in respect of uncompleted iterations, the creation and storage of fault artefacts within the system as a whole is thereby reduced (or even avoided completely); corruption of subsequent evaluation results by the incorrect data from an incomplete iteration is also prevented. Furthermore, fault-handling in this manner helps to ensure idempotence of the system—running the system with the same input parameters and settings should produce the same or corresponding evaluation results.

Many modifications may be made to the above examples without departing from the scope of the present disclosure as defined in the accompanying claims. For example, it will be appreciated that although the data store 12 is shown as being separate from (but in operative communication with) the master pod 2, the master pod 2 may in fact comprise the data store 12. Furthermore, each of the worker pod 4 may comprise their own individual data stores to which the evaluation data is initially written when executing the training jobs. The data from the worker pod individual data stores may then be periodically written to the main data store 12, for example after a certain number of iterations, or after success/failure of the entire job.

What is claimed is:

1. A computing system for optimising a machine learning process, the computing system being implemented using a cluster computing infrastructure comprising a plurality of computing nodes, the computing system comprising at an application level:
a processing master pod arranged to manage the optimisation, the processing master pod being configured to maintain a shared work queue comprising a plurality of machine learning model training operations, each model training operation comprising an associated set of hyperparameter configurations to be evaluated during the training operation, wherein each training operation is configured to be executed for a pre-defined number of iterations;
a shared repository configured to store a plurality of records, each record corresponding to one of the model training operations in the shared work queue; and
a plurality of processing worker pods, each worker pod being in operative communication with the shared work queue and the shared repository, and being configured to:
access, from the shared work queue, a model training operation;
retrieve, from the shared repository, the corresponding record for the accessed model training operation;
execute the pre-defined number of iterations for the accessed model training operation; and
for each executed iteration, output evaluation result data associated with the corresponding iteration to the shared repository for storage in the corresponding record.

2. The computing system of claim 1, wherein each model training operation has an associated completion time period within which execution of each of the iterations is to be completed.

3. The computing system of claim 2, wherein upon expiration of the completion time period, if the execution of the corresponding iteration is incomplete:
the iteration is deemed to not have been successful; and
the model training operation is configured to be returned to the shared work queue for access and execution by a different one of the plurality of processing worker pods.

4. The computing system of claim 2, wherein each worker pod is configured to, after executing each iteration of the model training operation, reset the completion time period in relation to a subsequent iteration of the model training operation.

5. The computing system of claim 1, wherein each worker pod is further configured to, upon retrieving the corresponding record for the model training operation:
determine whether the accessed model training operation has previously been executed by a different processing worker pod, and if so, determine a last successful iteration of the model training operation; and
implement the executing and outputting steps in respect of each of the remaining iterations that are not deemed successful.

6. The computing system of claim 5, wherein each worker pod is configured to, upon determining that the accessed model training operation has previously been executed by a different processing worker pod, access the corresponding record in the shared repository and delete any evaluation result data stored in association with the record in respect of all iterations subsequent to the last successful iteration.

7. The computing system of claim 1, wherein the set of hyperparameter configurations for each model training operation comprises one or more of the following: (a) a combination of hyperparameter input values; (b) a hyperparameter search space; (c) an objective metric to be achieved as a result of the model training operation; and (d) a search algorithm to be used.

8. The computing system of claim 7, wherein where the set of hyperparameter configurations comprises a combination of hyperparameter input values, these hyperparameter values are randomly generated.

9. The computing system of claim 7, wherein where the set of hyperparameter configurations comprises a search algorithm to be used, this search algorithm corresponds to a random search function or a grid search function.

10. A computer-implemented method for optimising a machine learning process comprising:
creating, by a processing master pod, a shared work queue comprising a plurality of machine learning model training operations, each model training operation comprising an associated set of hyperparameter configurations to be evaluated during the training operation, wherein each training operation is configured to be executed for a pre-defined number of iterations;
maintaining, by a shared repository, a plurality of stored records, each record corresponding to one of the model training operations in the shared work queue; and
for each of a plurality of processing worker pods in operative communication with the shared work queue and the shared repository:
accessing, from the shared work queue, a model training operation;
retrieving, from the shared repository, the corresponding record for the accessed model training operation;
executing the pre-defined number of iterations for the accessed model training operation; and
for each executed iteration, outputting evaluation result data associated with the corresponding iteration to the shared repository for storage in the corresponding record.

11. The method of claim 10, further comprising, upon retrieving, by the processing worker pod and from the shared repository, the corresponding record for the model training operation:
determining, by the processing worker pod, whether the accessed model training operation has previously been executed by a different processing worker pod, and if so, determine a last successful iteration of the model training operation; and
implementing, by the processing worker pod, the executing and outputting steps in respect of each of the remaining iterations that are not deemed successful.

12. The method of claim 11, wherein upon determining that the accessed model training operation has previously been executed by a different processing worker pod:
accessing, by a currently implementing worker pod, the corresponding record in the shared repository; and
deleting, by the currently implementing worker pod, any evaluation result data stored in association with the record in respect of all iterations subsequent to the last successful iteration.

13. The method of claim 10, wherein each model training operation has an associated completion time period within which execution of each of the iterations is to be completed, and preferably wherein upon expiration of the completion time period, if the execution of the corresponding iteration is incomplete:
the iteration is deemed to not have been successful; and
the model training operation is configured to be returned to the shared work queue for access and execution by a different one of the plurality of processing worker pods.

14. The method of claim 13, further comprising:
resetting, by the worker pod and after executing each iteration of the model training operation, the completion time period in relation to a subsequent iteration of the model training operation.

15. The method of claim 10, wherein the machine learning model is a neural network.

16. A computer storage medium having computer-executable instructions that, upon execution by a processor, cause the processor to at least:
create, by a processing master pod, a shared work queue comprising a plurality of machine learning model training operations, each model training operation comprising an associated set of hyperparameter configurations to be evaluated during the training operation, wherein each training operation is configured to be executed for a pre-defined number of iterations;
maintain, by a shared repository, a plurality of stored records, each record corresponding to one of the model training operations in the shared work queue; and
for each of a plurality of processing worker pods in operative communication with the shared work queue and the shared repository:
access, from the shared work queue, a model training operation;
retrieve, from the shared repository, the corresponding record for the accessed model training operation;
execute the pre-defined number of iterations for the accessed model training operation; and
for each executed iteration, output evaluation result data associated with the corresponding iteration to the shared repository for storage in the corresponding record.

17. The computer storage medium of claim 16, further comprising, upon retrieving, by the processing worker pod and from the shared repository, the corresponding record for the model training operation:
determining, by the processing worker pod, whether the accessed model training operation has previously been executed by a different processing worker pod, and if so, determine a last successful iteration of the model training operation; and
implementing, by the processing worker pod, the executing and outputting steps in respect of each of the remaining iterations that are not deemed successful.

18. The computer storage medium of claim 17, wherein upon determining that the accessed model training operation has previously been executed by a different processing worker pod:
accessing, by a currently implementing worker pod, the corresponding record in the shared repository; and
deleting, by the currently implementing worker pod, any evaluation result data stored in association with the record in respect of all iterations subsequent to the last successful iteration.

19. The computer storage medium of claim 16, wherein each model training operation has an associated completion time period within which execution of each of the iterations is to be completed, and preferably wherein upon expiration of the completion time period, if the execution of the corresponding iteration is incomplete:
the iteration is deemed to not have been successful; and
the model training operation is configured to be returned to the shared work queue for access and execution by a different one of the plurality of processing worker pods.

20. The computer storage medium of claim 19, further comprising:
resetting, by the worker pod and after executing each iteration of the model training operation, the completion time period in relation to a subsequent iteration of the model training operation.
